(19) United States
(12) Patent Application Publication
(10) Pub. No.: US 2025/0118477 A1
(43) Pub. Date: Apr. 10, 2025

(54) MAGNETIC CORE STRUCTURE AND MAGNETIC COMPONENT

(71) Applicant: LITE-ON Technology Corporation, Taipei City (TW)

(72) Inventors: Yi-Wen CHENG, Taipei City (TW); Yen-An CHEN, Taipei City (TW); Cheng-Wei TSENG, Taipei City (TW); De-Jia LU, Taipei City (TW); Chen CHEN, Taipei City (TW); Chao-Lin CHUNG, Taipei City (TW)

(21) Appl. No.: 18/747,411

(22) Filed: Jun. 18, 2024

Related U.S. Application Data
(60) Provisional application No. 63/588,303, filed on Oct. 6, 2023.

(30) Foreign Application Priority Data
May 8, 2024 (TW) 113117010

(51) Int. Cl. H01F 27/24; H01F 27/30; H01F 27/32

(52) U.S. Cl. CPC H01F 27/24; H01F 27/306; H01F 27/325

(57) ABSTRACT

Disclosed are a magnetic core structure and a magnetic component. The magnetic core structure includes N winding columns and two cover plates, and N is a positive integer, wherein each winding column is provided with a first hollow channel, the two cover plates are disposed at two ends of each winding column, each cover plate is provided with N first through holes, the N winding columns are in a one-to-one correspondence with the N first through holes of each cover plate, and the first hollow channel of each winding column is communicated with the first through holes located on two sides thereof and corresponding thereto. Therefore, the channels for air flow can be added, so that the heat dissipation efficiency is improved when the magnetic core structure is applied to the magnetic component.

### CROSS REFERENCE TO RELATED PRESENT DISCLOSURE

This application claims the priority benefit of U.S. Provisional Application Ser. No. 63/588,303, filed on Oct. 6, 2023, and Taiwan Patent Application Serial Number 113117010, filed on May 8, 2024, and the full disclosures of which are incorporated herein by reference.

### TECHNICAL FIELD

The present disclosure relates to a magnetic core structure and a magnetic component, and in particular to a magnetic core structure and a magnetic component that can improve the heat dissipation efficiency.

### RELATED ART

Magnetic components, such as transformers and inductors, are widely used in power supplies. As the volumetric power density of the power supply increases, the temperature of the magnetic component rises due to high power output. If the internal heat dissipation of the magnetic component is poor, it is easy to cause problems such as poor operating performance, reduced reliability, and shortened service life of the magnetic components.

Therefore, how to provide a magnetic core structure, which is conducive to dissipating the heat generated by the operation of the magnetic component to improve the heat dissipation efficiency when applied to a magnetic component, has become one of the important issues.

### SUMMARY

Embodiments of the present disclosure provide a magnetic core structure and a magnetic component. The structural design of the magnetic core structure facilitates dissipation of heat generated by the operation of the magnetic component, thereby improving the heat dissipation efficiency.

This application provides a magnetic core structure, which includes N winding columns and two cover plates, where N is a positive integer. Each winding column is provided with a first hollow channel. The two cover plates are disposed at two ends of each winding column. Each cover plate is provided with N first through holes. The N winding columns are in a one-to-one correspondence with the N first through holes of each cover plate. The first hollow channel of each winding column is communicated with the first through holes located on two sides thereof and corresponding thereto.

The present disclosure provides a magnetic component, which includes the magnetic core structure of the present disclosure and N windings. The N windings are wound around the N winding columns of the magnetic core structure, and N is a positive integer.

The present disclosure further provides a magnetic component, which includes a magnetic core structure, a bobbin and a coil. The magnetic core structure includes a winding column, two cover plates and two supporting columns. The winding column is provided with a first hollow channel. The two cover plates are disposed at two ends of the winding column, each cover plate is provided with a first through hole, the winding column corresponds to the first through hole of each cover plate, and the first hollow channel of the winding column is communicated with the first through holes located on two sides thereof and corresponding thereto. Two ends of each supporting column are connected to the two cover plates, the two supporting columns are respectively disposed on two sides of each cover plate, and the winding column is disposed between the two supporting columns. Each cover plate is further provided with two second through holes disposed on opposite sides of the first through hole. The bobbin includes a hollow sleeve, at least two blades disposed on two ends of the hollow sleeve, and at least one rib disposed on an outer surface of the hollow sleeve. The winding column is accommodated in the hollow sleeve, and one side of each blade is recessed with a groove, and the groove of each blade corresponding to the second through hole adjacent thereto. The coil is wound around the outer surface of the hollow sleeve and contacts the at least one rib, so that a gap is formed between the coil and the outer surface of the hollow sleeve. A projection of each cover plate onto the other cover plate covers the at least one rib and each blade.

In the magnetic core structure of the embodiment of the present disclosure, by the first hollow channel of each winding column being communicated with the first through holes located on two sides thereof and corresponding thereto, the channels for air flow can be added, so that the heat dissipation efficiency is improved when the magnetic core structure is applied to the magnetic component. In addition, in the magnetic component of the embodiment of the present disclosure, by the designs where the first hollow channel of the winding column is communicated with the first through holes located on two sides thereof and corresponding thereto, the winding column is accommodated in the hollow sleeve, a gap is formed between the coil and the outer surface of the hollow sleeve since the coil is wound on the rib disposed on the outer surface of the hollow sleeve, the groove of each blade corresponds to the second through hole adjacent thereto, and the projection of each cover plate onto the other cover plate covers the rib and each blade, the air can pass through the cover plate through the first hollow channel, and at the same time, the air can pass through the cover plate through the second through hole without being blocked by the rib, so as to establish effective air channels, thereby improving the heat dissipation efficiency.

### BRIEF DESCRIPTION OF THE DRAWINGS

Accompanying drawings described herein are intended to provide a further understanding of the present disclosure and form a part of the present disclosure, and exemplary embodiments of the present disclosure and descriptions thereof are intended to explain the present disclosure but are not intended to unduly limit the present disclosure. In the drawings:

FIG. 1 is a perspective view of a magnetic component according to a first embodiment of the present disclosure;

FIG. 2 is an exploded view of the magnetic component of FIG. 1;

FIG. 3 is a cross-sectional view of the magnetic component of FIG. 1 along line AA′;

FIG. 4 is a perspective view of a magnetic component according to a second embodiment of the present disclosure;

FIG. 5 is a cross-sectional view of the magnetic component of FIG. 4 along line BB′;

FIG. 6 is a perspective view of a magnetic component according to a third embodiment of the present disclosure;

FIG. 7 is an exploded view of the magnetic component of FIG. 6;

FIG. 8 is a top view of the four windings and four winding columns of FIG. 7 disposed on the cover plate;

FIG. 9 is a perspective view of a magnetic component according to a fourth embodiment of the present disclosure;

FIG. 10 is an exploded view of the magnetic component of FIG. 9;

FIG. 11 is a top view of the four windings and four winding columns of FIG. 9 disposed on the cover plate;

FIG. 12 is an exploded view of a magnetic component according to a fifth embodiment of the present disclosure;

FIG. 13 is a top view of the two supporting columns, two winding columns and two windings of FIG. 12 disposed on the cover plate;

FIG. 14 is an exploded view of a magnetic component according to a sixth embodiment of the present disclosure;

FIG. 15 is an assembly diagram of the magnetic component of FIG. 14;

FIG. 16 is a perspective view of a magnetic component according to a seventh embodiment of the present disclosure;

FIG. 17 is a side view of the magnetic core structure of FIG. 16;

FIG. 18 is a schematic diagram of a cover plate according to an embodiment of the present disclosure;

FIG. 19 is a schematic diagram of a cover plate according to another embodiment of the present disclosure;

FIG. 20 is a perspective view of a magnetic component according to an eighth embodiment of the present disclosure;

FIG. 21 is a cross-sectional view of the magnetic component of FIG. 20 along line CC′;

FIG. 22 is a perspective view of a magnetic component according to a nineth embodiment of the present disclosure; and

FIG. 23 is an assembled side view of the magnetic component of FIG. 22.

### DETAILED DESCRIPTION OF THE EMBODIMENTS

The embodiments of the present disclosure will be described below in conjunction with the relevant drawings. In the figures, the same reference numbers refer to the same or similar components or method flows.

It must be understood that the words “including”, “comprising” and the like used in this specification are used to indicate the existence of specific technical features, values, method steps, work processes, elements and/or components. However, it does not exclude that more technical features, values, method steps, work processes, elements, components, or any combination of the above can be added.

It must be understood that when an element is described as being “connected” or “coupled” to another element, it may be directly connected or coupled to another element, and intermediate elements therebetween may be present. In contrast, when an element is described as “directly connected” or “directly coupled” to another element, there is no intervening element therebetween.

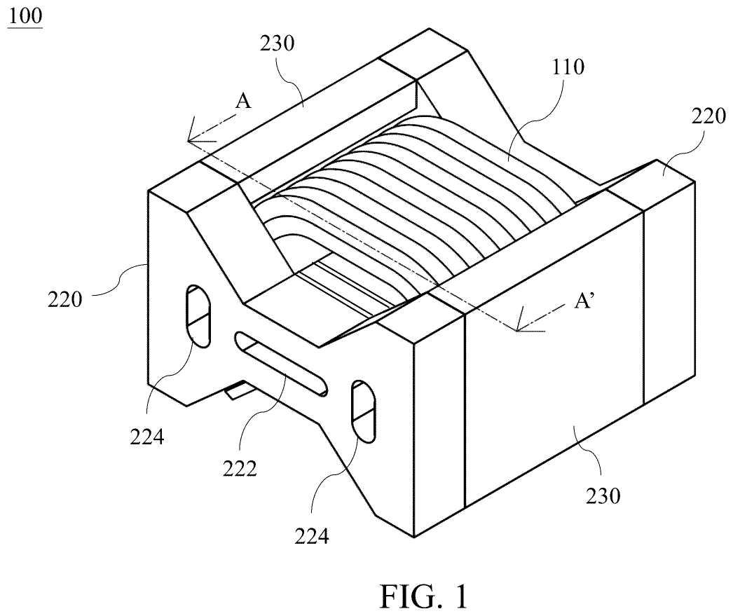

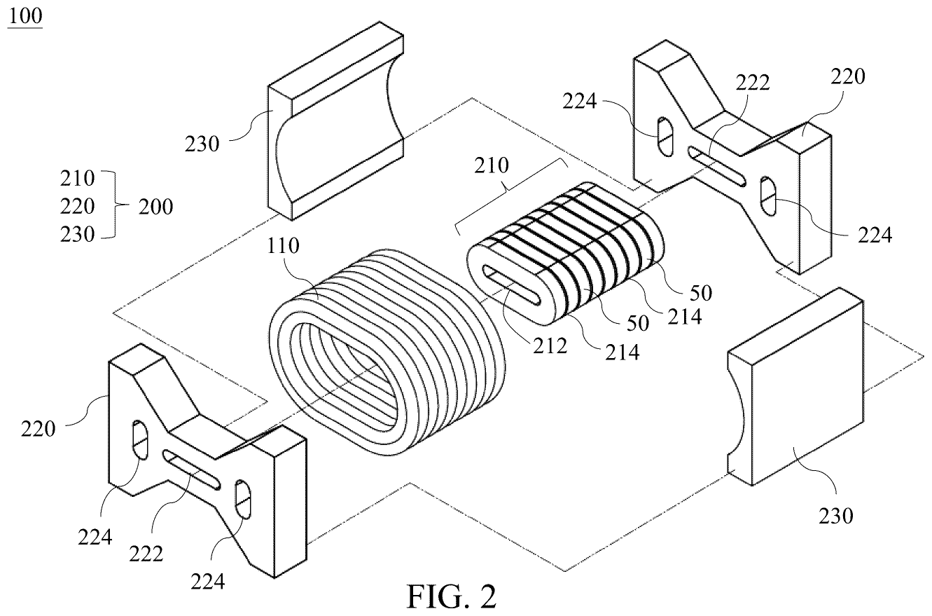

Please refer to FIG. 1 and FIG. 2. FIG. 1 is a perspective view of a magnetic component according to a first embodiment of the present disclosure, and FIG. 2 is an exploded view of the magnetic component of FIG. 1. As shown in FIG. 1 and FIG. 2, a magnetic component 100 comprises a winding 110 and a magnetic core structure 200. The magnetic component 100 may be, but is not limited to, an inductor, and the winding 110 may be, but is not limited to, a circular coil, a flat coil or a copper sheet winding.

In this embodiment, the magnetic core structure 200 comprises a winding column 210 and two cover plates 220. The winding column 210 is provided with a first hollow channel 212, and the winding 110 is wound around the winding column 210. The two cover plates 220 are disposed at two ends of the winding column 210. Each cover plate 220 is provided with a first through hole 222. The winding column 210 corresponds to the first through hole 222 of each cover plate 220. The first hollow channel 212 of the winding column 210 is communicated with the first through holes 222 located on two sides thereof and corresponding thereto. The two cover plates 220 have the same structure and are arranged opposite to each other. The material of the winding column 210 and the cover plate 220 may be an iron powder core with low magnetic permeability, such as Fe—Si based alloy and Fe—Ni based alloy, or a ferrite core with high magnetic permeability, but this embodiment is not intended to limit this disclosure.

By the first hollow channel 212 of the winding column 210 being communicated with the first through holes 222 located on two sides thereof and corresponding thereto, the channels for air flow can be added, and the heat dissipation area can be increased, so as to help the magnetic core structure 200 cool down, so that the heat dissipation efficiency can be improved when the magnetic core structure 200 is applied to the magnetic component 100. In addition, to further improve the heat dissipation efficiency, it may be considered to reduce the number of turns of the winding 110 or adjust the wire diameter of the winding 110 to reduce the heat source or adjust the ratio of copper loss to iron loss.

In one embodiment, the bobbin 210 may have distributed air gaps 214. In other words, the winding column 210 may comprise a plurality of hollow magnetic columns 50, and there may be an air gap 214 between any two adjacent hollow magnetic columns 50.

In one embodiment, there may be an air gap between the winding column 210 and each cover plate 220.

In one embodiment, the magnetic core structure 200 may further comprise two supporting columns 230. Two ends of each supporting column 230 are connected to the two cover plates 220. The two supporting columns 230 may be respectively disposed on two sides of each cover plate 220, and the winding column 210 is disposed between the two supporting columns 230. The material of the supporting column 230 may be an iron powder core with low magnetic permeability or a ferrite core with high magnetic permeability.

In one embodiment, each cover plate 220 is further provided with two second through holes 224 disposed on opposite sides of the first through hole 222. Therefore, by the second through holes 224 of the cover plate 220, the channels for air flow can be added, and the heat dissipation area can be increased, which can help the magnetic core structure 200 cool down when the magnetic core structure 200 is applied to the magnetic component 100, thereby improving the heat dissipation efficiency.

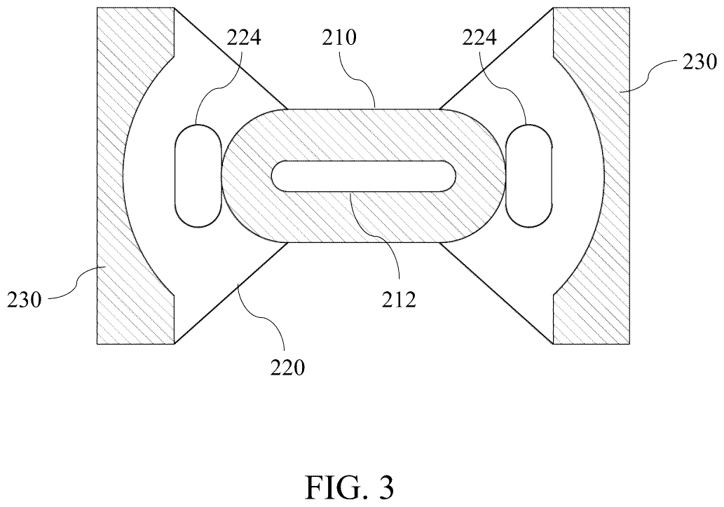

Please refer to FIG. 3, which is a cross-sectional view of the magnetic component of FIG. 1 along line AA′. As shown in FIG. 3, a cross-sectional area of the first hollow channel 212 and an area of each second through hole 224 may be less than or equal to 50% of a cross-sectional area of the winding column 210. The first hollow channel 212 is communicated with the first through hole 222, and the cross-sectional shape and size of the first hollow channel 212 may be equal to the shape and size of the first through hole 222. The winding column 210 may be, but is not limited to, an elliptical column, and may have a first hollow channel 212 with a cross-sectional shape of an ellipse.

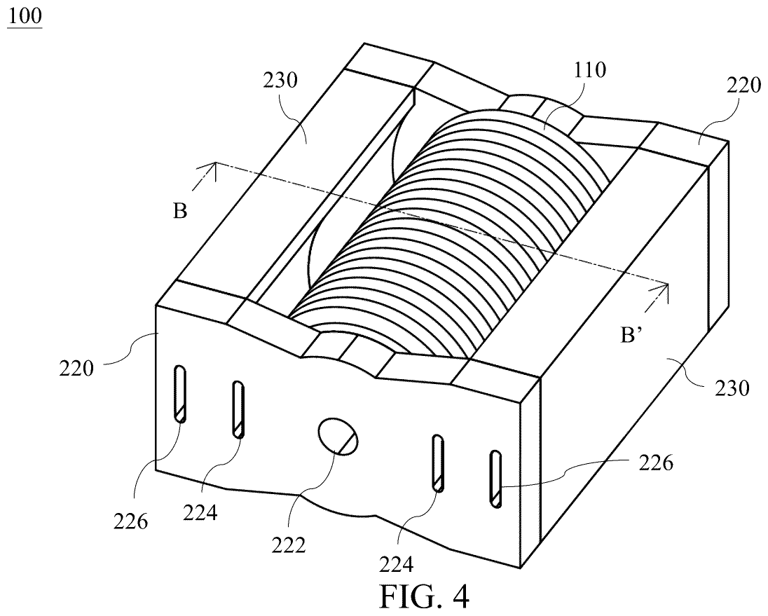

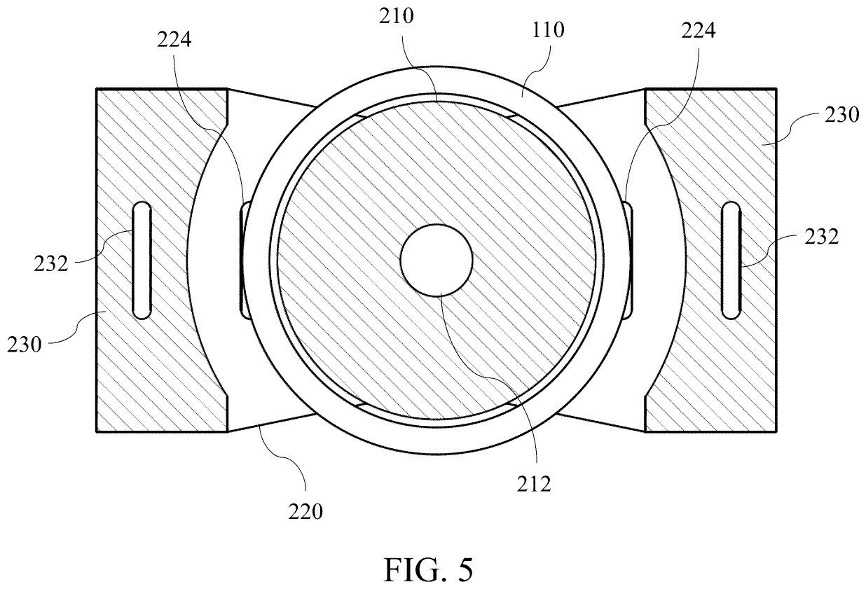

Please refer to FIG. 4 and FIG. 5. FIG. 4 is a perspective view of a magnetic component according to a second embodiment of the present disclosure, and FIG. 5 is a cross-sectional view of the magnetic component of FIG. 4 along line BB′. As shown in FIG. 4 and FIG. 5, the differences between the second embodiment and the first embodiment are that each cover plate 220 may be further provided with two third through holes 226, two supporting columns 230 and two third through holes 226 of each cover plate 220 are arranged in one-to-one correspondence, each supporting column 230 is provided with a second hollow channel 232, and the second hollow channel 232 of each supporting column 230 is communicated with the third through holes 226 located on two sides thereof and corresponding thereto. The two cover plates 220 have the same structure and are arranged opposite to each other. The cross-sectional shape and size of the first hollow channel 212 may be equal to the shape and size of the first through hole 222, and the cross-sectional shape and size of the second hollow channel 232 may be equal to the shape and size of the third through hole 226 corresponding thereto. The winding column 210 may be, but is not limited to, a circular columnar body, and may have a first hollow channel 212 with a circular cross-sectional shape. The total area of the first through hole 222 and the two third through holes 226 of the cover plate 220 may be less than or equal to 80% of the area of the surface of the cover plate 220 away from the winding column 210. Therefore, by the second hollow channel 232 of each supporting column 230 being communicated with the third through holes 226 located on two sides thereof and corresponding thereto, the channels for air flow can be added, and the heat dissipation area can be increased, so as to help the magnetic core structure 200 cool down, so that the heat dissipation efficiency can be improved when the magnetic core structure 200 is applied to the magnetic component 100.

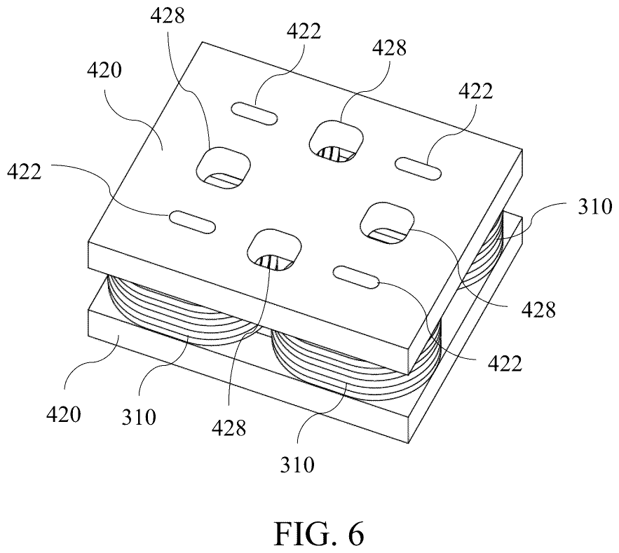

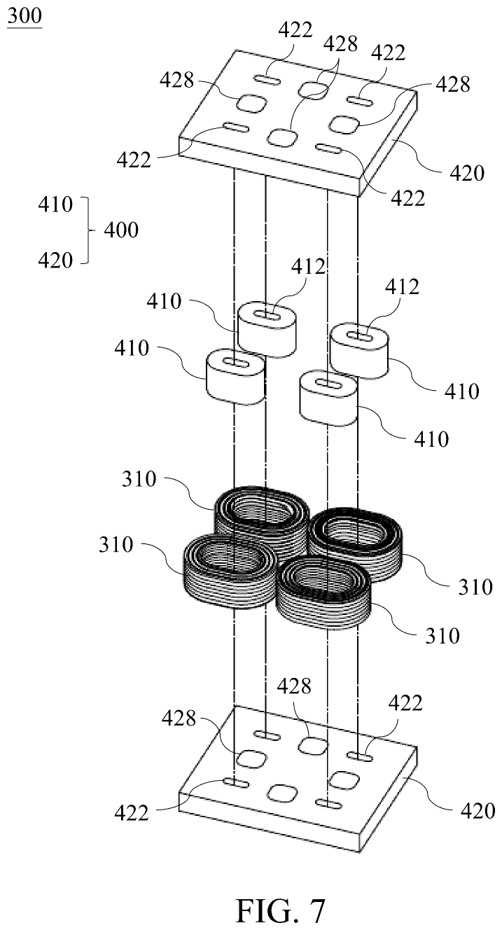

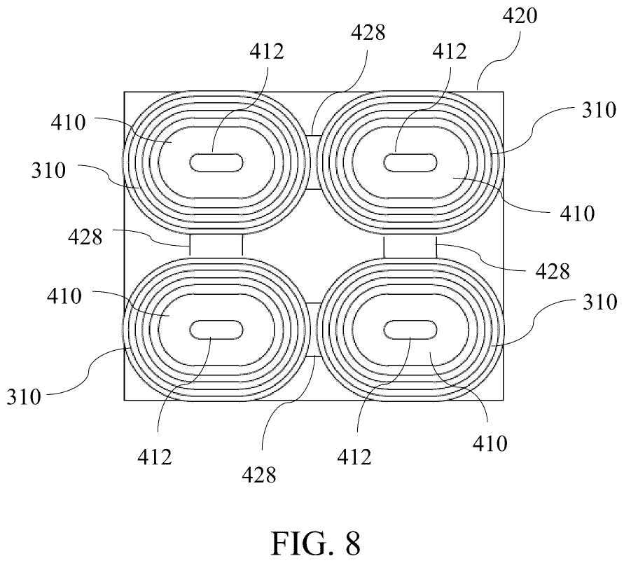

Please refer to FIG. 6 to FIG. 8. FIG. 6 is a perspective view of a magnetic component according to a third embodiment of the present disclosure, FIG. 7 is an exploded view of the magnetic component of FIG. 6, and FIG. 7 is an exploded view of the magnetic component of FIG. 6, and FIG. 8 is a top view of the four windings and four winding columns of FIG. 7 disposed on the cover plate. As shown in FIG. 6 to FIG. 8, a magnetic component 300 comprises four windings 310 and a magnetic core structure 400. The magnetic component 300 may be, but is not limited to, an inductor, and the winding 310 may be, but is not limited to, a circular coil, a flat coil or a copper sheet winding. In this embodiment, the magnetic core structure 400 comprises four winding columns 410 and two cover plates 420. Each winding column 410 is provided with a first hollow channel 412, and the four windings 310 are wound around the four winding columns 410. The two cover plates 420 are disposed at two ends of each winding column 410, each cover plate 420 is provided with four first through holes 422, the four winding columns 410 are in a one-to-one correspondence with the four first through holes 422 of each cover plate 420, and the first hollow channel 412 of each winding column 410 is communicated with the first through holes 422 located on two sides thereof and corresponding thereto. The material of the winding column 410 and the cover plate 420 may be an iron powder core with low magnetic permeability or a ferrite core with high magnetic permeability. In addition, each cover plate 420 is provided with a fourth through hole 428 between any two adjacent first through holes 422. Since the four first through holes 422 of the cover plate 420 are arranged in a matrix in this embodiment, so the cover plate 420 is provided with four fourth through holes 428.

The two cover plates 420 have the same structure and are arranged opposite to each other. The cross-sectional shape and size of the first hollow channel 412 may be equal to the shape and size of the first through hole 422. The winding column 410 may be, but is not limited to, an elliptical column, and a cross-sectional shape of the first hollow channel 412 of the winding column 410 is, for example, an ellipse. The total area of the four first through holes 422 and the four fourth through holes 428 of the cover plate 420 may be less than or equal to 80% of the area of the surface of the cover plate 420 away from the four winding columns 410. Therefore, by the first hollow channel 412 of the winding column 410 being communicated with the first through holes located on two sides thereof and corresponding thereto, and the arrangement of the fourth through holes 428, the channels for air flow can be added, and the heat dissipation area can be increased, which can help the magnetic core structure 400 and the winding 310 to cool down when the magnetic core structure 400 is applied to the magnetic component 300, thereby improving the heat dissipation efficiency.

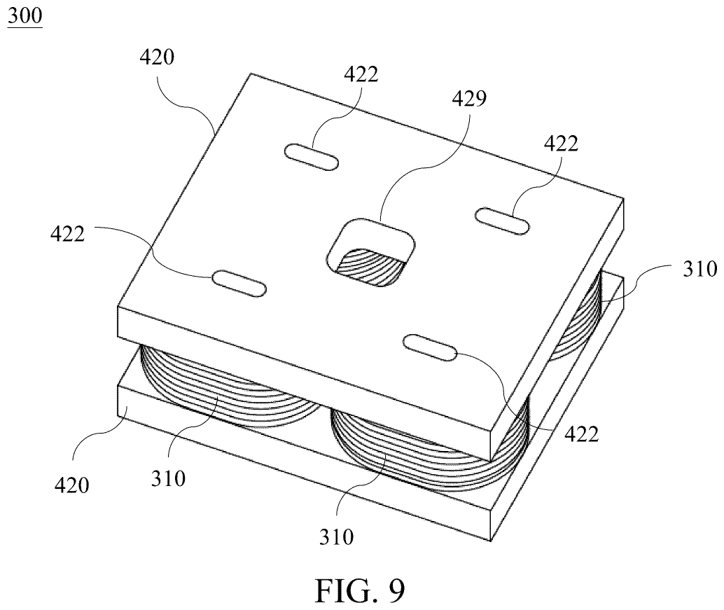

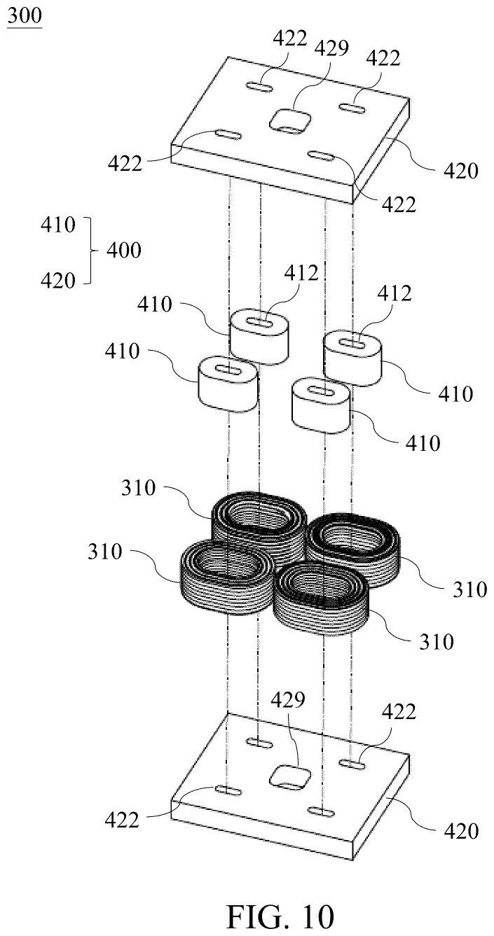

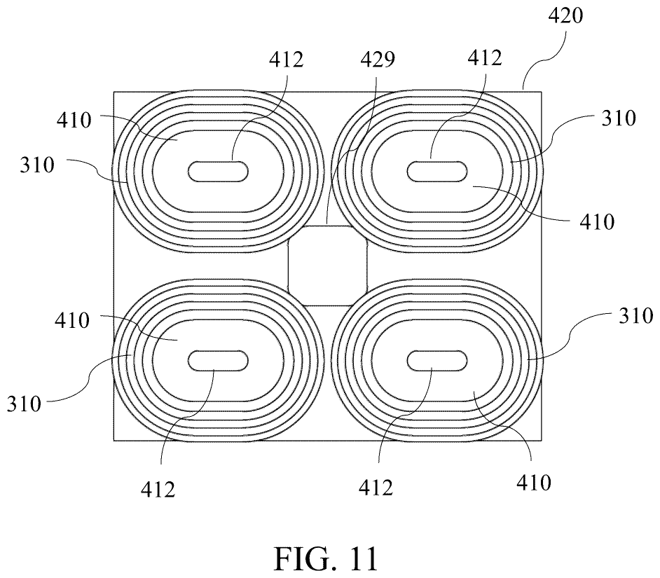

Please refer to FIG. 9 to FIG. 11. FIG. 9 is a perspective view of a magnetic component according to a fourth embodiment of the present disclosure, FIG. 10 is an exploded view of the magnetic component of FIG. 9, and FIG. 11 is a top view of the four windings and four winding columns of FIG. 9 disposed on the cover plate. As shown in FIG. 9 to FIG. 11, the differences between the fourth embodiment and the third embodiment are that each cover plate 420 is not provided with the fourth through hole 428, but may be provided with a fifth through hole 429 located at a center among distribution positions of the four first through holes 422. The total area of the four first through holes 422 and the fifth through hole 429 of the cover plate 420 may be less than or equal to 80% of the area of the surface of the cover plate 420 away from the four winding columns 410. Therefore, by the first hollow channel 412 of the winding column 410 being communicated with the first through holes 422 located on two sides thereof and corresponding thereto, and the arrangement of the fifth through hole 429, the channels for air flow can be added, and the heat dissipation area can be increased, which can help the magnetic core structure 400 and the winding 310 to cool down when the magnetic core structure 400 is applied to the magnetic component 300, thereby improving the heat dissipation efficiency.

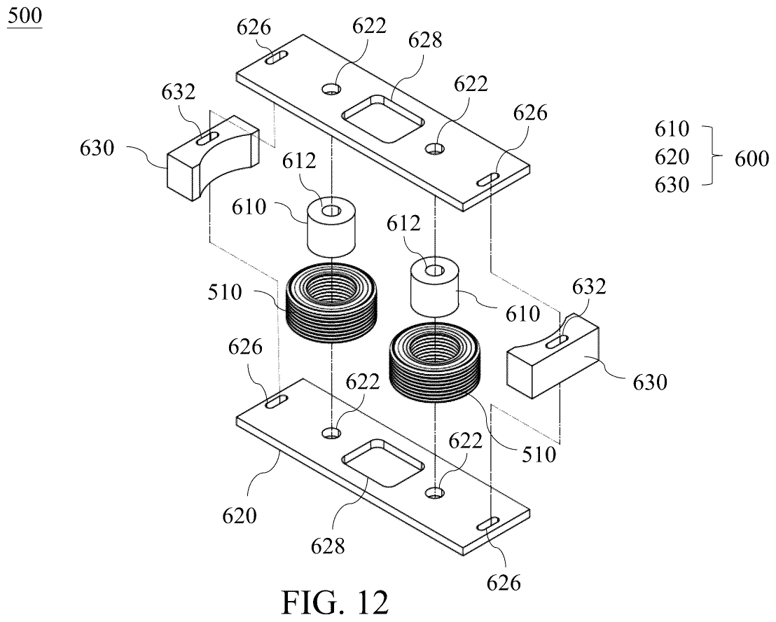

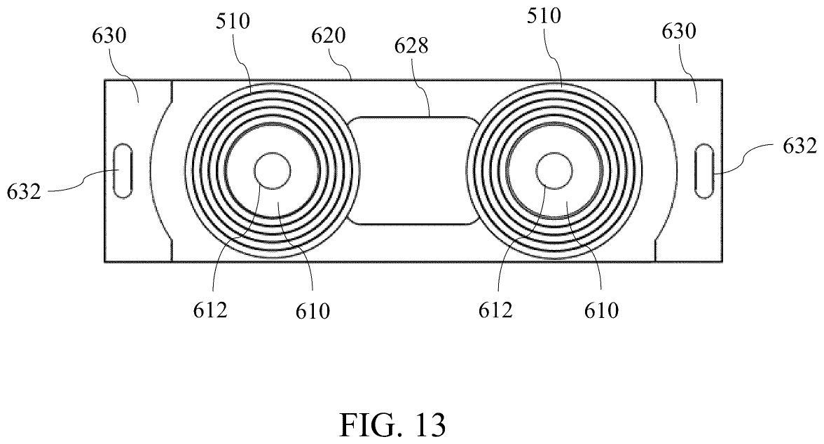

Please refer to FIG. 12 and FIG. 13. FIG. 12 is an exploded view of a magnetic component according to a fifth embodiment of the present disclosure, and FIG. 13 is a top view of the two supporting columns, two winding columns and two windings of FIG. 12 disposed on the cover plate. As shown in FIG. 12 and FIG. 13, a magnetic component 500 comprises two windings 510 and a magnetic core structure 600. The magnetic component 500 may be, but is not limited to, an inductor, and the winding 510 may be, but is not limited to, a circular coil, a flat coil or a copper sheet winding. The magnetic core structure 600 comprises two winding columns 610, two cover plates 620 and two supporting columns 630. Each winding column 610 is provided with a first hollow channel 612, and the two windings 510 are wound around the two winding columns 610. The two cover plates 620 are disposed at two ends of each winding column 610, each cover plate 620 is provided with two first through holes 622, the two winding columns 610 are in a one-to-one correspondence with the two first through holes 622 of each cover plate 620, and the first hollow channel 612 of each winding column 610 is communicated with the first through holes 622 located on two sides thereof and corresponding thereto. The two ends of each supporting column 630 are connected to the two cover plates 620, the two supporting columns 630 are respectively disposed on two sides of each cover 620, and the two winding columns 610 are disposed between the two supporting columns 630. In addition, each cover plate 620 is provided with a fourth through hole 628 between two adjacent first through holes 622. Besides, the cross-sectional shape and size of the first hollow channel 612 may be equal to the shape and size of the first through hole 622, and the total area of the two first through holes 622 and the fourth through hole 628 of the cover plate 620 may be less than or equal to 80% of the area of the surface of the cover plate 620 away from the two winding columns 610. Therefore, by the first hollow channel 612 of the winding column 610 being communicated with the first through holes 622 located on two sides thereof and corresponding thereto, and the arrangement of the fourth through hole 628, the channels for air flow can be added, and the heat dissipation area can be increased, which can help the magnetic core structure 600 and the windings 510 to cool down when the magnetic core structure 600 is applied to the magnetic component 500, thereby improving the heat dissipation efficiency.

In one embodiment, each cover plate 620 may be further provided with two third through holes 626, and the two support columns 630 and the two third through holes 626 of each cover plate 620 are arranged in one-to-one correspondence. Each supporting column 630 is provided with a second hollow channel 632, and the second hollow channel 632 of each supporting column 630 is communicated with the third through holes 626 located on two sides thereof and corresponding thereto. The cross-sectional shape and size of the second hollow channel 632 may be equal to the shape and size of the third through hole 626, and the total area of the two first through holes 622, the fourth through holes 628 and the two third through holes 626 of the cover plate 620 may be less than or equal to 80% of the area of the surface of the cover 620 away from the two winding columns 610. Therefore, by the second hollow channel 632 of the supporting column 630 being communicated with the third through holes 626 located on two sides thereof and corresponding thereto, the channels for air flow can be added, and the heat dissipation area can be increased, so as to help the magnetic core structure 600 to cool down, so that the heat dissipation efficiency can be improved when the magnetic core structure 600 is applied to the magnetic component 500.

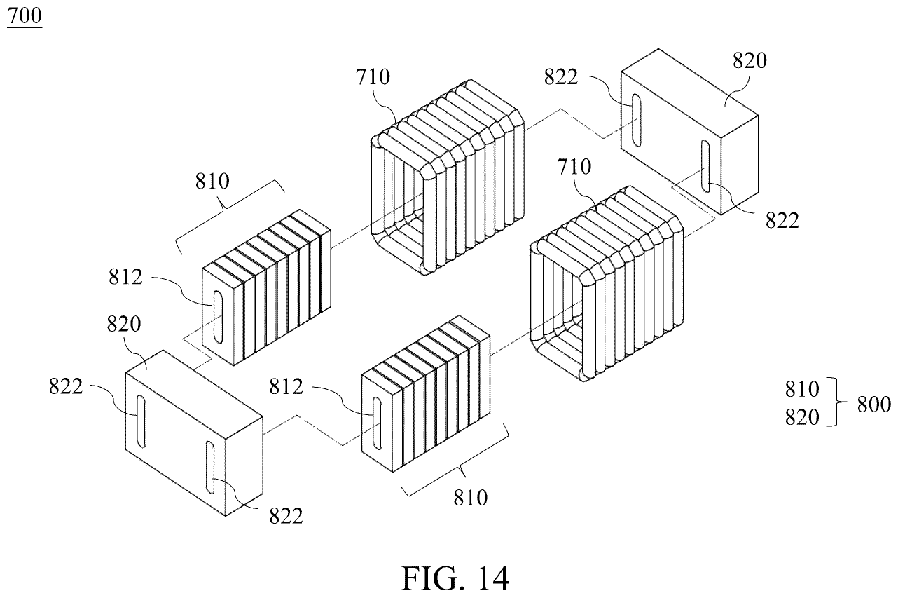

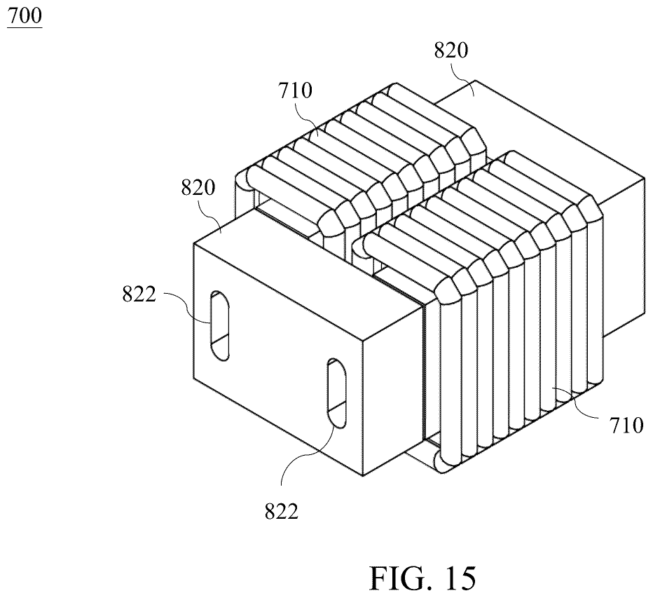

Please refer to FIG. 14 and FIG. 15. FIG. 14 is an exploded view of a magnetic component according to a sixth embodiment of the present disclosure, and FIG. 15 is an assembly diagram of the magnetic component of FIG. 14. As shown in FIG. 14 and FIG. 15, a magnetic component 700 comprises two windings 710 and a magnetic core structure 800. The magnetic component 700 may be, but is not limited to, an inductor, and the winding 710 may be, but is not limited to, a circular coil, a flat coil or a copper sheet winding. The magnetic core structure 800 comprises two winding columns 810 and two cover plates 820. Each winding column 810 is provided with a first hollow channel 812. The two winding columns 810 are respectively disposed on two sides of each cover plate 820, and two windings 710 are wound around the two winding columns 810. The two cover plates 820 are disposed at two ends of each winding column 810, each cover plate 820 is provided with two first through holes 822, the two winding columns 810 are in a one-to-one correspondence with the two first through holes 822 of each cover plate 820, and the first hollow channel 812 of each winding column 810 is communicated with the first through holes 822 located on two sides thereof and corresponding thereto. Therefore, by the first hollow channel 812 of the winding column 810 being communicated with the first through holes 822 located on two sides thereof and corresponding thereto, the channels for air flow can be added, and the heat dissipation area can be increased, so as to help the magnetic core structure 800 to cool down, so that the heat dissipation efficiency can be improved when the magnetic core structure 800 is applied to the magnetic component 700.

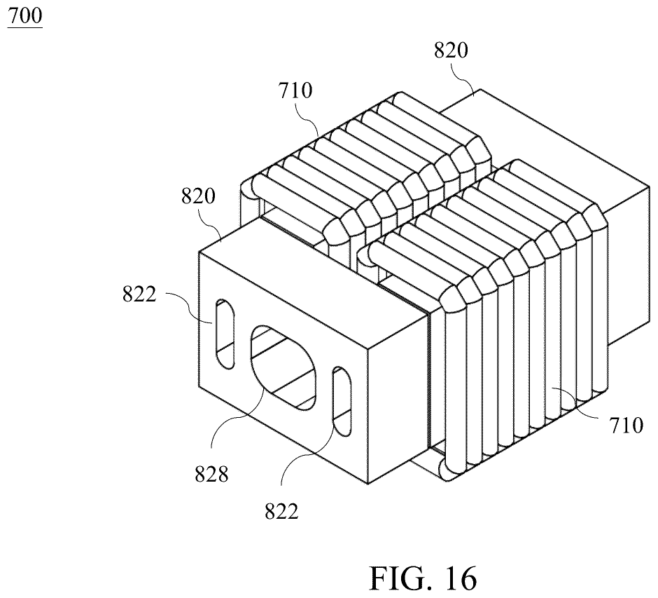

In one embodiment, each cover plate 820 is provided with a fourth through hole 828 between two adjacent first through holes 822, as shown in FIG. 16, which is a perspective view of a magnetic component according to a seventh embodiment of the present disclosure.

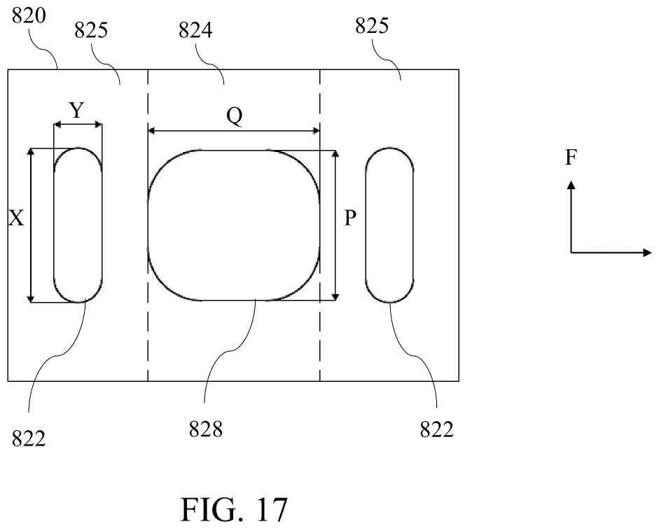

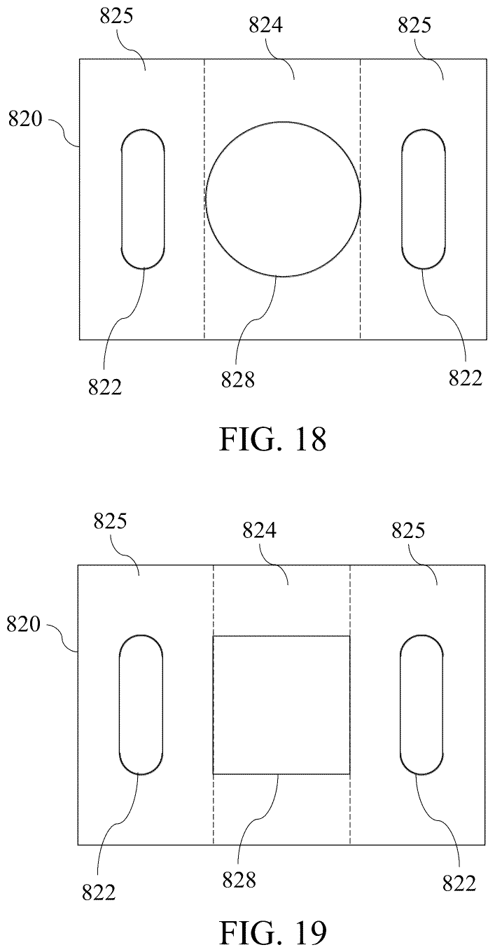

Please refer to FIG. 16 and FIG. 17. FIG. 17 is a side view of the magnetic core structure of FIG. 16. As shown in FIG. 16 and FIG. 17, a surface of the cover plate 820 away from the two winding columns 810 comprises a middle region 824 and two side regions 825 on two sides of the middle region 824. The middle region 824 corresponds to the fourth through hole 828, and the two side regions 825 correspond to the two first through holes 822. In this embodiment, the edges between the middle region 824 and the two side regions 825 shown as dotted lines in FIG. 17 coincide with tangent lines or edges of the fourth through hole 828, the area of the fourth through hole 828 may be less than or equal to 80% of the area of the middle region 824, and the area of each first through hole 822 may be less than or equal to 80% of the area of the side region 825 corresponding thereto. It should be noted that, in other applications, the tangent lines or edges of the fourth through hole 828 may not coincide with the edges between the middle region 824 and the two side regions 825, and the present disclosure is not limited thereto. The contour of the fourth through hole 828 may be, but is not limited to, a rectangle shown in FIG. 17, a square shown in FIG. 18, an ellipse or a circle shown in FIG. 19, wherein FIG. 18 is a schematic diagram of a cover plate according to an embodiment of the present disclosure, FIG. 19 is a schematic diagram of a cover plate according to another embodiment of the present disclosure; the rectangle may be, but is not limited to, a rounded rectangle or a right-angled rectangle, and the square may be, but is not limited to, a rounded square or a right-angled square. In the case where the first through hole 822 maintains the same shape and size and the fourth through holes 828 with the similar cross-sectional area have different shapes, the magnetic flux and iron loss generated when the contour of the fourth through hole 828 is a rounded rectangle are smaller than the magnetic flux and iron loss generated when the contour of the fourth through hole 828 is a square or a circle.

In one embodiment, an aspect ratio of the fourth through hole 828 may be in the range from 0.95 to 1.05. The aspect ratio of the fourth through hole 828 is the ratio between the length P of the fourth through hole 828 in the first direction F and the length Q of the fourth through hole 828 in the second direction S, wherein the first direction F and the second direction S are perpendicular to each other. In addition, in the case where the first through hole 822 maintains the same shape and size and the fourth through holes 828 with the contour of a rounded rectangle have different aspect ratios, the magnetic flux and iron loss generated when the aspect ratio of the fourth through hole 828 is in the range from 0.95 to 1.05 are smaller than the magnetic flux and iron loss generated when the fourth through hole 828 has other aspect ratios.

In one embodiment, a contour of each first through hole 822 may be, but is not limited to, a rectangle or a square, wherein the rectangle may be, but is not limited to, a rounded rectangle or a right-angled rectangle; the square may be, but is not limited to, a rounded rectangle or a right-angled rectangle; and an aspect ratio of each first through hole 822 is in the range from 0.95 to 1.05. The aspect ratio of the first through hole 822 is the ratio between the length X of the first through hole 822 in the first direction F and the length Y of the first through hole 822 in the second direction S, wherein the first direction F and the second direction S are perpendicular to each other. In addition, in the case where the fourth through holes 828 maintains the same shape and size and the first through hole 822 with the contour of a rounded rectangle have different aspect ratios, the magnetic flux and iron loss generated when the aspect ratio of the first through hole 822 is in the range from 0.95 to 1.05 are smaller than the magnetic flux and iron loss generated when the first through hole 822 has other aspect ratios.

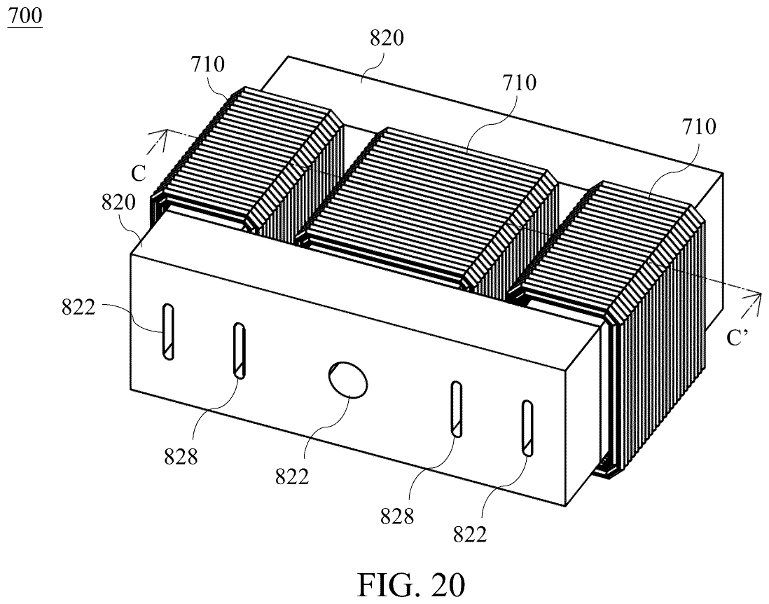

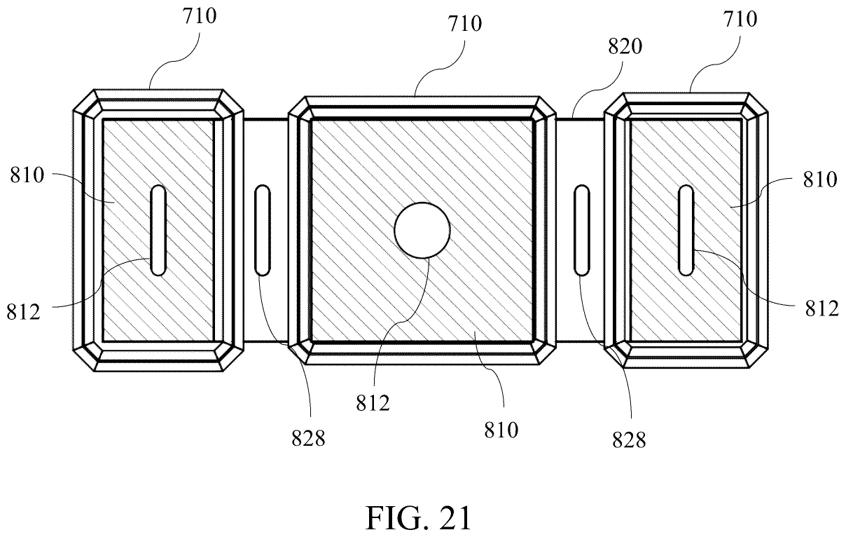

Please refer to FIG. 20 and FIG. 21. FIG. 20 is a perspective view of a magnetic component according to an eighth embodiment of the present disclosure, and FIG. 21 is a cross-sectional view of the magnetic component of FIG. 20 along line CC′. As shown in FIG. 20 and FIG. 21, the differences between the eighth embodiment and the sixth embodiment are that the number of winding columns 810 is three, two winding columns 810 of the three winding columns 810 are respectively disposed on two sides of each cover plate 820, and the other winding column 810 is disposed between the two winding columns 810. In addition, since a fourth through holes 828 is disposed between two adjacent first through holes 822, the number of the fourth through holes 828 of the cover plate 820 of the seventh embodiment is two.

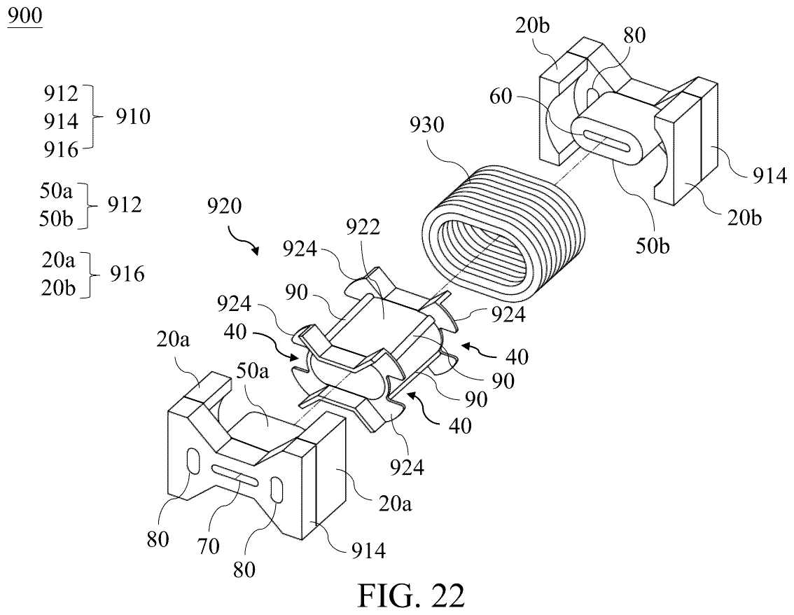

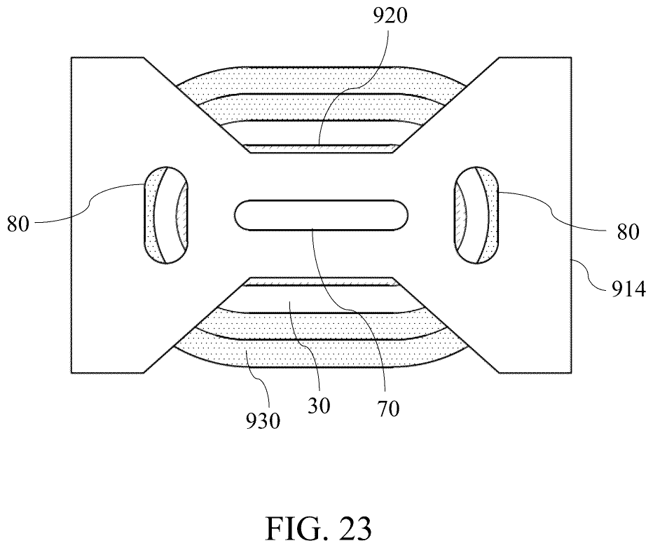

Please refer to FIG. 22 and FIG. 23. FIG. 22 is a perspective view of a magnetic component according to a nineth embodiment of the present disclosure, and FIG. 23 is an assembled side view of the magnetic component of FIG. 22. As shown in FIG. 22 and FIG. 23, a magnetic component 900 comprises a magnetic core structure 910, a bobbin 920 and a coil 930. The magnetic core structure 910 comprises a winding column 912, two cover plates 914 and two supporting columns 916, the winding column 912 is provided with a first hollow channel 60, and the two cover plates 914 are disposed at two ends of the winding column 912. Each cover plate 914 is provided with a first through hole 70 and two second through holes 80 disposed on opposite sides of the first through hole 70. The winding column 912 corresponds to the first through hole 70 of each cover plate 914. The first hollow channel 60 of the winding column 912 is communicated with the first through holes 70 located on two sides thereof and corresponding thereto. Two ends of each supporting column 916 are connected to the two cover plates 914, the two supporting columns 916 are respectively disposed on two sides of each cover plate 914, and the winding column 912 is disposed between the two supporting columns 916. The bobbin 920 comprises a hollow sleeve 922, at least two blades 924 disposed on two ends of the hollow sleeve 922, and at least one rib 90 disposed on an outer surface of the hollow sleeve 922. The winding column 912 is accommodated in the hollow sleeve 922, one side of each blade 924 is recessed with a groove 40, and the groove 40 of each blade 924 corresponds to the second through hole 80 adjacent thereto. The coil 930 is wound around the outer surface of the hollow sleeve 922 and contacts the at least one rib 90, so that a gap 30 is formed between the coil 930 and the outer surface of the hollow sleeve 922. A projection of each cover plate 914 onto the other cover plate 914 covers the at least one rib 90 and each blade 924.

The number of ribs 90 may be, but is not limited to, four, and the four ribs 90 are disposed at diagonal positions on the outer surface of the hollow sleeve 922, but this embodiment is not intended to limit the present disclosure. It should be noted that a rib 90 cannot be displayed in the drawing of FIG. 22 due to the viewing angle.

In addition, the winding column 912 may comprise a hollow magnetic column 50a and a hollow magnetic column 50b. One end of the hollow magnetic column 50a is connected to one cover plate 914, there is an air gap or connection between the other end of the hollow magnetic column 50a and one end of the hollow magnetic column 50b, and the other end of the hollow magnetic column 50b is connected to another cover plate 914.

Besides, the supporting column 916 may comprise a first magnetic column 20a and a second magnetic column 20b. One end of the first magnetic column 20a is connected to one cover plate 914, there is an air gap or connection between the other end of the first magnetic column 20a and one end of the second magnetic column 20b, and the other end of the second magnetic column 20b is connected to another cover plate 914.

Therefore, by the designs where the first hollow channel 60 of the winding column 912 is communicated with the first through holes 70 located on two sides thereof and corresponding thereto, the winding column 912 is accommodated in the hollow sleeve 922 of the bobbin 920, a gap 30 is formed between the coil 930 and the outer surface of the hollow sleeve 922 since the coil 930 is wound on the rib 90 disposed on the outer surface of the hollow sleeve 922, the groove 40 of each blade 924 corresponds to the second through hole 80 adjacent thereto, and the projection of each cover plate 914 onto the other cover plate 914 covers the rib 90 and the blades 924, the air can pass through the cover plate 914 through the first hollow channel 60, and at the same time, the air can pass through the cover plate 914 through the second through hole 80 without being blocked by the rib 90, so as to establish effective air channels, thereby improving the heat dissipation efficiency. In addition, in order to further improve the heat dissipation efficiency, it may be considered to reduce the number of turns of the coil 930 to reduce the heat source or copper loss and reduce the accumulated heat of the coil 930.

In summary, in the magnetic core structure of the embodiment of the present disclosure, by the first hollow channel of each winding column being communicated with the first through holes located on two sides thereof and corresponding thereto, the second hollow channel of the supporting column being communicated with the third through holes located on two sides thereof and corresponding thereto, or the cover plate being provided with the second through hole, the fourth through hole and/or the fifth through hole, which can help the magnetic core structure cool down when the magnetic core structure is applied to the magnetic component, thereby improving the heat dissipation efficiency. In addition, in the magnetic component of the embodiment of the present disclosure, by the designs where the first hollow channel of the winding column is communicated with the first through holes located on two sides thereof and corresponding thereto, the winding column is accommodated in the hollow sleeve, a gap is formed between the coil and the outer surface of the hollow sleeve since the coil is wound on the rib disposed on the outer surface of the hollow sleeve, the groove of each blade corresponds to the second through hole adjacent thereto, and the projection of each cover plate onto the other cover plate covers the rib and the blades, the air can pass through the cover plate through the first hollow channel, and at the same time, the air can pass through the cover plate through the second through hole without being blocked by the rib, so as to establish effective air channels, thereby improving the heat dissipation efficiency.

While the present disclosure is disclosed in the foregoing embodiments, it should be noted that these descriptions are not intended to limit the present disclosure. On the contrary, the present disclosure covers modifications and equivalent arrangements obvious to those skilled in the art. Therefore, the scope of the claims must be interpreted in the broadest manner to comprise all obvious modifications and equivalent arrangements.

What is claimed is:

1. A magnetic core structure, comprising:
N winding columns, each winding column being provided with a first hollow channel, wherein N is a positive integer; and
two cover plates, the two cover plates being disposed at two ends of each winding column, each cover plate being provided with N first through holes, the N winding columns being in a one-to-one correspondence with the N first through holes of each cover plate, the first hollow channel of each winding column being communicated with the first through holes located on two sides thereof and corresponding thereto.

2. The magnetic core structure according to claim 1, further comprising two supporting columns, wherein two ends of each supporting column are connected to the two cover plates, the two supporting columns are respectively disposed on two sides of each cover plate, and the N winding columns are disposed between the two supporting columns.

3. The magnetic core structure according to claim 2, wherein when N is equal to 1, each cover plate is further provided with two second through holes disposed on opposite sides of the first through hole.

4. The magnetic core structure according to claim 3, wherein a cross-sectional area of the first hollow channel and an area of each second through hole are both less than or equal to 50% of a cross-sectional area of the winding column.

5. The magnetic core structure according to claim 2, wherein each cover plate is further provided with two third through holes, the two supporting columns and the two third through holes of each cover plate are arranged in one-to-one correspondence, each supporting column is provided with a second hollow channel, and the second hollow channel of each supporting column is communicated with the third through holes located on two sides thereof and corresponding thereto.

6. The magnetic core structure according to claim 1, wherein when N is greater than or equal to 2, each cover plate is provided with a fourth through hole between any two adjacent first through holes.

7. The magnetic core structure according to claim 6, further comprising two supporting columns, wherein two ends of each supporting column are connected to the two cover plates, the two supporting columns are respectively disposed on two sides of each cover plate, and the N winding columns are disposed between the two supporting columns.

8. The magnetic core structure according to claim 7, wherein each cover plate is further provided with two third through holes, the two supporting columns and the two third through holes of each cover plate are arranged in one-to-one correspondence, each supporting column is provided with a second hollow channel, and the second hollow channel of each supporting column is communicated with the third through holes located on two sides thereof and corresponding thereto.

9. The magnetic core structure according to claim 6, wherein two winding columns of the N winding columns are respectively disposed on two sides of each cover plate.

10. The magnetic core structure according to claim 9, wherein when N is equal to 2, a surface of each cover plate away from the two winding columns comprises a middle region and two side regions located on two sides of the middle region, the middle region corresponds to the fourth through hole, the two side regions correspond to the two first through holes, edges between the middle region and the two side regions coincide with tangent lines or edges of the fourth through hole, an area of the fourth through hole is less than or equal to 80% of an area of the middle region, and an area of each first through hole is less than or equal to 80% of an area of the side region corresponding thereto.

11. The magnetic core structure according to claim 9, wherein when N is equal to 2, a contour of the fourth through hole is a rectangle, a square, an ellipse or a circle, and an aspect ratio of the fourth through hole is in the range from 0.95 to 1.05.

12. The magnetic core structure according to claim 9, wherein when N is equal to 2, a contour of each first through hole is a rectangle or a square, and an aspect ratio of each first through hole is in the range from 0.95 to 1.05.

13. The magnetic core structure according to claim 1, wherein when N is greater than or equal to 2, the N first through holes of each cover plate are arranged in a matrix, and each cover plate is further provided with a fifth through hole located at a center among distribution positions of the N first through holes.

14. The magnetic core structure according to claim 1, wherein when N is equal to 1, each cover plate is further provided with two second through holes disposed on opposite sides of the first through hole.

15. A magnetic component, comprising:
the magnetic core structure according to claim 1; and
N windings wound around the N winding columns.

16. The magnetic component according to claim 15, wherein the magnetic core structure further comprises two supporting columns, two ends of each supporting column are connected to the two cover plates, the two supporting columns are respectively disposed on two sides of each cover plate, and the N winding columns are disposed between the two supporting columns.

17. The magnetic component according to claim 15, wherein when N is greater than or equal to 2, each cover plate is provided with a fourth through hole between any two adjacent first through holes.

18. The magnetic component according to claim 15, wherein when N is greater than or equal to 2, the N first through holes of each cover plate are arranged in a matrix, and each cover plate is further provided with a fifth through hole located at a center among distribution positions of the N first through holes.

19. The magnetic component according to claim 15, wherein when N is equal to 1, each cover plate is further provided with two second through holes disposed on opposite sides of the first through hole.

20. A magnetic component, comprising:
the magnetic core structure according to claim 3;
a bobbin comprising a hollow sleeve, at least two blades disposed on two ends of the hollow sleeve, and at least one rib disposed on an outer surface of the hollow sleeve, the winding columns being accommodated in the hollow sleeve, one side of each blade being recessed with a groove, the groove of each blade corresponding to the second through hole adjacent thereto; and
a coil wound around the outer surface and contacting the at least one rib, so that a gap is formed between the coil and the outer surface;
wherein a projection of each cover plate onto the other cover plate covers the at least one rib and each blade.
